(19) United States
(12) Patent Application Publication
(10) Pub. No.: US 2011/0026920 A1
(43) Pub. Date: Feb. 3, 2011

(54) Systems and Methods of Supporting Powerline Communications

(75) Inventor: Don Gunasekara, Reston, VA (US)

Correspondence Address: Crowell & Moring LLP, Intellectual Property Group, P.O. Box 14300, Washington, DC, 20044-4300, US

(73) Assignee: Clear Wireless LLC, Kirkland, WA (US)

(21) Appl. No.: 12/534,280

(22) Filed: Aug. 3, 2009

(51) Int. Cl. H04J 14/00

(52) U.S. Cl. 398/43

(57) ABSTRACT

Systems and methods for supporting communications over powerlines are provided. The system can include a frequency and amplitude selective optical converter coupled to a powerline, an optical multiplexer coupled to the optical converter and an optical demultiplexer coupled to the optical multiplexer. The optical converter can be tuned to a frequency and amplitude corresponding to voice or data communication signals carried on the powerline.

### BACKGROUND OF THE INVENTION

There are a variety of different transmission interfaces for communications, including wireless and wired communications. Wired communications are typically employed over wires dedicated solely for supporting communications, e.g., the public switched telephone network (PSTN). Another type of wired communications, commonly referred to as powerline communications, employs electrical powerlines to carry communications. In particular, communication signals are modulated onto the powerline by a transmitter and then demodulated by a receiver. Because there is a much larger existing infrastructure for electrical powerlines compared to dedicated communication lines, the infrastructure costs of deploying a powerline communication system can be reduced compared to dedicated communication line systems.

### SUMMARY OF THE INVENTION

Powerlines are noisy environments. For example, powerlines typically act like large antennas, absorbing a variety of radio frequency interference. Moreover, appliances typically introduce interference into powerlines. Conventional techniques for mitigating noise on powerlines involve line filters. These filters, however, are ineffective in removing in and out of band hystersis and noise levels.

In view of the above-identified and other deficiencies of conventional powerline communication techniques, exemplary embodiments of the present invention provide systems and methods of mitigating noise in powerlines. An exemplary system includes a frequency and amplitude selective optical converter coupled to a powerline. The system also includes an optical multiplexer coupled to the optical converter and an optical demultiplexer coupled to the optical multiplexer. The optical converter is tuned to a frequency and amplitude corresponding to voice or data communication signals carried on the powerline.

The optical converter can include a first diode tuned to pass signals with a first frequency and a first amplitude and a second diode tuned to pass signals with a second frequency and a second amplitude, where the first and second frequencies correspond to a frequency bandwidth of a communication signal. The first and second diodes can be PIN diodes or light emitting diodes (LEDs).

The optical converter can also include a third diode tuned to pass signals with a third frequency and the first amplitude and a fourth diode tuned to pass signals with a fourth frequency and the second amplitude, where the third and fourth frequencies correspond to a frequency bandwidth of another communication signal.

The first frequency can be approximately 2.4 GHz, the second frequency can be approximately 2.5 GHz, the third frequency can be approximately 1800 MHz and the fourth frequency can be approximately 1900 MHz.

The first and third diodes are light diodes and the second and fourth diodes are dark diodes.

The system can also include an optical-to-wireless converter coupled to the optical demultiplexer. The optical-to-wireless converter transmits wireless communication signals corresponding to the voice or data communication signals carried on the powerline.

Other objects, advantages and novel features of the present invention will become apparent from the following detailed description of the invention when considered in conjunction with the accompanying drawings.

### BRIEF DESCRIPTION OF THE DRAWING FIGURES

FIG. 1 is a block diagram of an exemplary powerline communication system in accordance with the present invention;

FIGS. 2A and 2B are block diagrams of exemplary systems for filtering powerline signals in accordance with the present invention; and

FIG. 3 is a graph of an exemplary powerline waveform and an exemplary filter in accordance with the present invention.

### DETAILED DESCRIPTION OF THE PREFERRED EMBODIMENTS

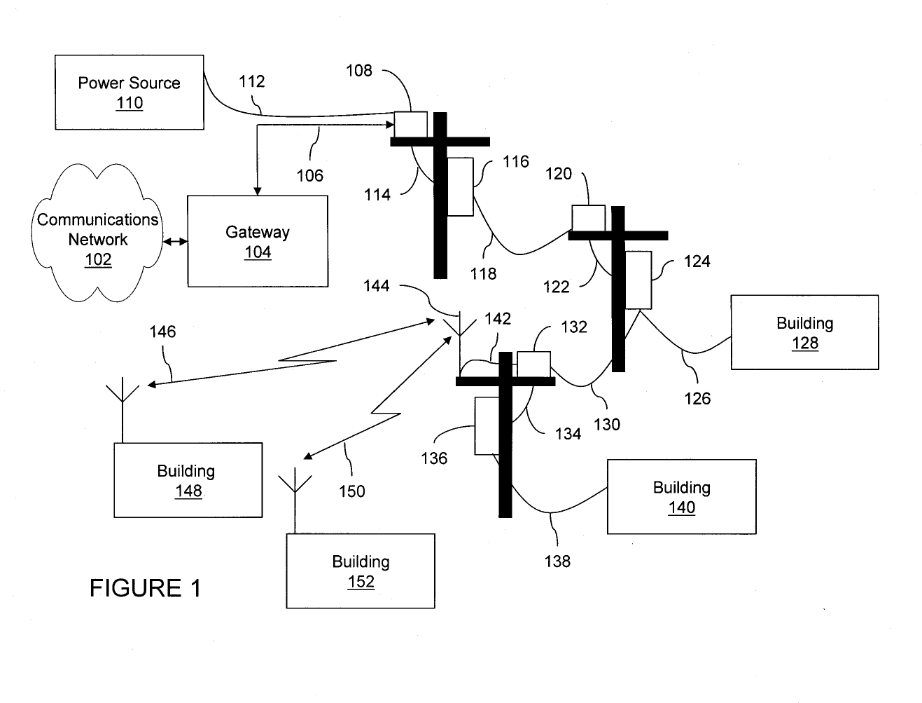

FIG. 1 is a block diagram of an exemplary powerline communication system in accordance with the present invention. The exemplary system couples a plurality of buildings 128, 140, 148 and 152 to a power source 110 and a communications network 102. Specifically, communications network 102 is coupled to gateway 104, which in turn is coupled by communications link 106 to powerline-communications coupler 108. Power source 110 is coupled by powerline 112 to powerline-communications coupler 108. Powerline-communications coupler 108 modulates communication signals from gateway 104 onto the power signals received from power source 110, and demodulates communications signals received from cable 114 for transmission to gateway 104. The communication signals can carry voice and/or data communications.

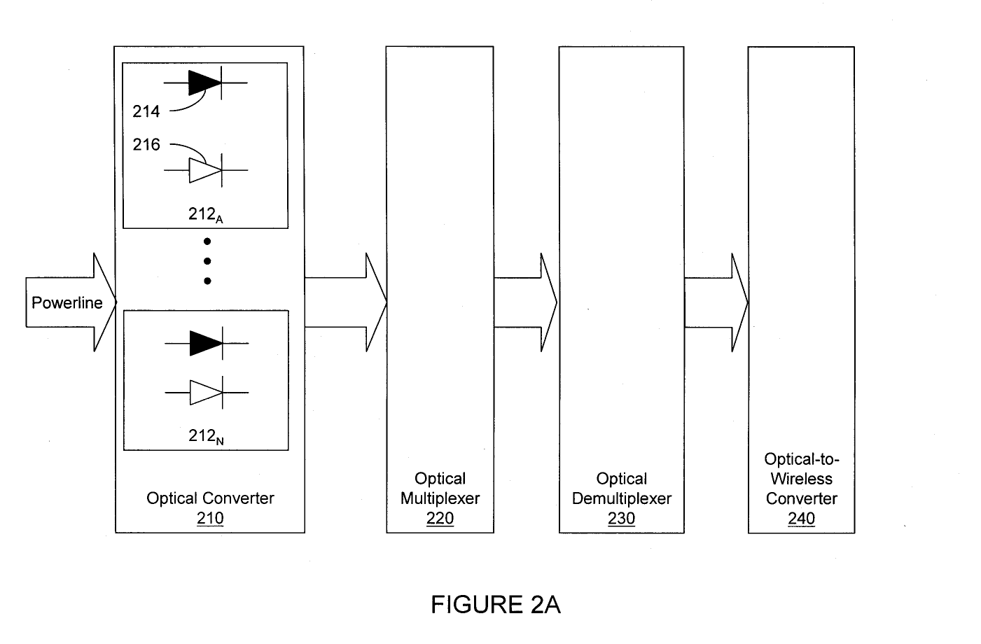

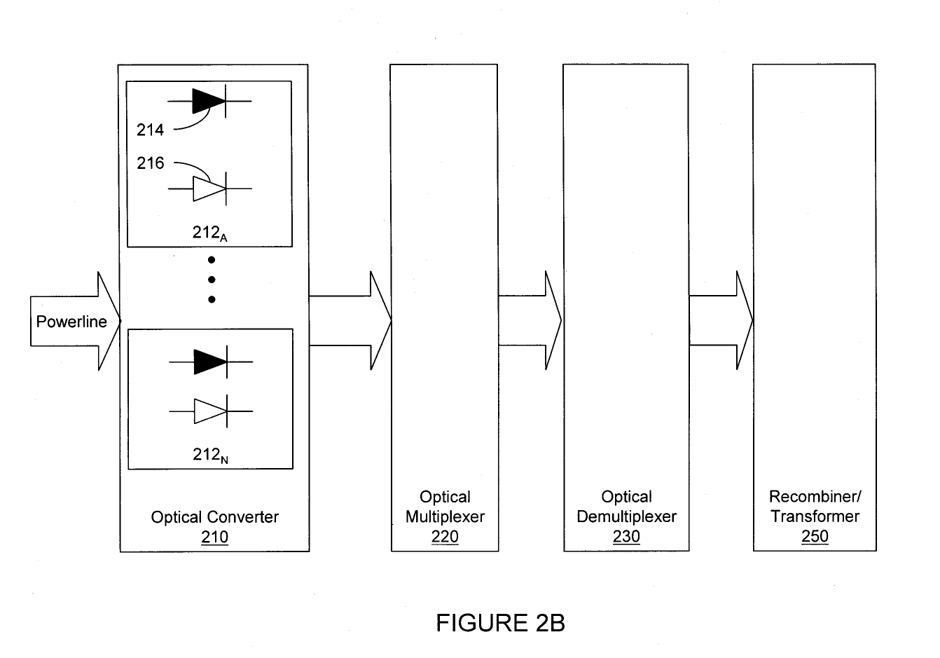

Powerline-communications coupler 108 provides the combined power and communication signal via cable 114 to transformer 116, which then provides the combined signal via powerline 118 to powerline-communications coupler 120. Powerline-communications coupler 120 can include a filtering and optical conversion system, such as that described in more detail below in connection with FIGS. 2A and 2B. Powerline-communications coupler 120 passes the filtered signal to transformer 124 via cable 122. Transformer 124 can provide the filtered signal to building 128 via powerline 126, and to another powerline-communications coupler 132 via powerline 130. Accordingly, building 128 not only receives power via powerline 126 but also can access communication network 102.

Powerline-communications coupler 132 filters the combined power and communication signals and passes the filtered signals via cable 134 to transformer 136 for delivery to building 140 via powerline 138. Powerline-communications coupler 132 also passes the combined signals via cable 142 to antenna 144 for delivery to buildings 148 and 152 via wireless communication links 146 and 150, respectively. Thus, building 140 can receive both power and access to communication network 102 via powerline 138. Additionally, buildings 148 and 152 can access communications network 102 without being connected by a powerline.

It should be recognized that the system of FIG. 1 is exemplary and that other arrangements are possible. Specifically, the system can include more than three powerline-communications couplers, more than one antenna, more than one communications network and/or the like. Additionally, although FIG. 1 illustrates buildings including antennas for accessing communications network 102, stationary or mobile wireless devices can likewise access communications network 102 via antenna 144. Thus, antenna 144 can provide a communications cell, the size of which depends upon the power of transmissions from the antenna. Furthermore, it should be recognized that antenna 144 can be configured as a repeater or a base station. When configured as a repeater, antenna 144 will include at least a power amplifier. When configured as a base station, antenna will include at least a power amplifier, a modulator/demodulator and one or more transceivers.

FIGS. 2A and 2B are block diagrams of exemplary systems for filtering powerline signals in accordance with the present invention. The system of FIG. 2A includes optical converter 210 coupled to an optical multiplexer 220, which in turn is coupled to an optical demultiplexer 230. When it is desired to provide the communication signals to an antenna, then optical demultiplexer 230 is coupled to optical-to-wireless converter 240. Otherwise, as illustrated in FIG. 2B, converter 240 is omitted and the output from demultiplexer 230 is passed to transformer 250. The arrangements of FIGS. 2A and 2B are not necessarily alternatives. Specifically, the filtering system of FIGS. 2A and 2B can be combined when used in powerline-communications coupler 132 such that the output of optical multiplexer can be coupled to both optical-to-wireless converter 240 and transformer 250.

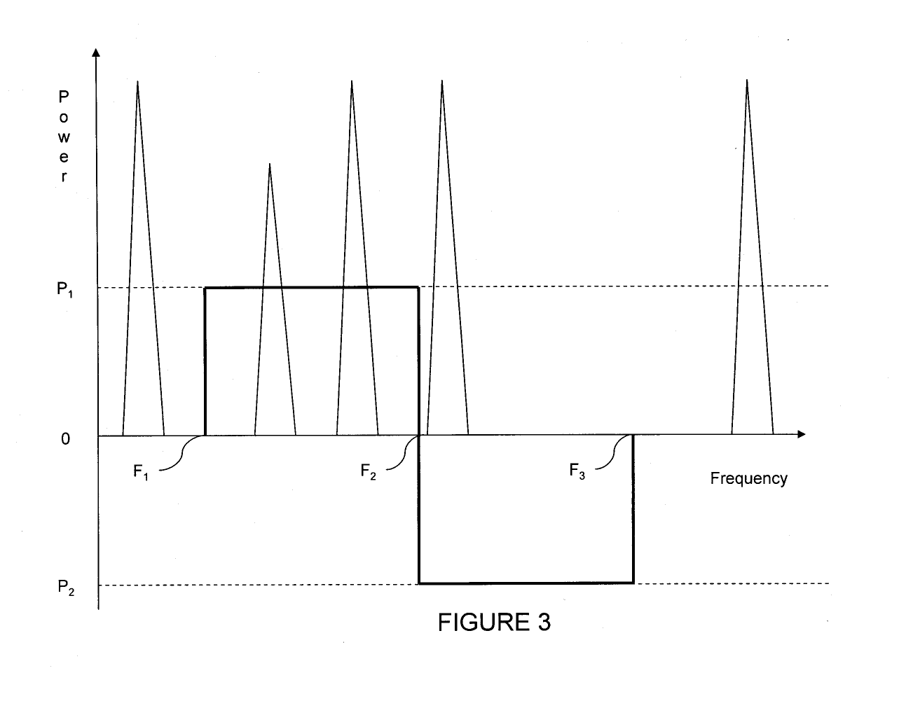

The operation of the systems of FIGS. 2A and 2B begins with optical converter 210 receiving the combined power and communication signal and filtering the combined signal using filters 212_{A}-212_{N}. Each of these filters includes two diodes, 214 and 216, which can be PIN diodes, light emitting diodes (LEDs) and/or the like. As illustrated in FIG. 2, diode 214 is a dark diode and diode 216 is a light diode. The dark and light diodes 214 and 216 are tuned to particular amplitudes and frequencies. Specifically, referring now to FIG. 3, dark diode 214 is tuned to pass signals with a power level between 0 and P₂ and a frequency between F₂ and F₃. All other signals input to dark diode 214 are filtered and not output from the diode. Similarly, light diode 216 is tuned to pass signals with a power level between 0 and P₁ and a frequency between F₁ and F₂. All other signals input to light diode 216 are filtered and not output from the diode. The outputs from dark diode 214 and light diode 216 of each filter are combined to form the square wave illustrated in FIG. 3.

Optical converter 210 includes a set of light and dark diodes tuned for each set of frequencies that carry communication signals. For example, assuming that the communication signals are in both the 1800 MHz band and the 2.4 GHz band, then a first filter 212_{A} can have one diode tuned between 1800 MHz and 1850 MHz and a second diode tuned between 1850 MHz and 1900 MHz, and a second filter 212_{B} can have one diode tuned between 2.3 GHz and 2.4 GHz and a second diode tuned between 2.4 GHz and 2.5 GHz. The amplitudes P₁ and P₂ are selected to be higher than the highest amplitude expected for a communication signal on the powerline. These amplitudes can also include an added hystersis amount above the highest amplitude expected for a communication signal on the powerline to account for any unexpected variations.

The output of filters 212_{A}-212_{N} are passed to optical multiplexer 220, which combines the filtered signals and passes them to optical demultiplexer 230, which again separates the filtered signals into their respective frequency bands. Optical multiplexer 220 and demultiplexer 230 each include a number of lenses that, in addition to the multiplexing and demultiplexing, provide further noise reduction. When the signal is to be passed to an antenna then the signal is passed to optical-to-wireless converter 240. When the signal is to be recombined with a power signal, then the output is passed to recombiner/transformer 250.

The present invention provides an exemplary system for removing noise from communication signals carried on powerlines. In-band noise that occurs at the same frequency as the carrier of the communication signals are filtered by controlling the amplitude passed by the filter and out-of-band noise is filtered by controlling the frequency of the filter. Additionally, the present invention does not require an external power source to operate the system. Instead, the power that is not passed by the filters can be used to power the filters, multiplexer, demultiplexer, optical-to-wireless converter and recombiner/transformer.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A system comprising:
a frequency and amplitude selective optical converter coupled to a powerline;
an optical multiplexer coupled to the optical converter; and
an optical demultiplexer coupled to the optical multiplexer,
wherein the optical converter is tuned to a frequency and amplitude corresponding to voice or data communication signals carried on the powerline.

2. The system of claim 1, wherein the optical converter comprises:
a first diode tuned to pass signals with a first frequency and a first amplitude; and
a second diode tuned to pass signals with a second frequency and a second amplitude,
wherein the first and second frequencies correspond to a frequency bandwidth of a communication signal.

3. The system of claim 2, wherein the first and second diodes are PIN diodes.

4. The system of claim 2, wherein the first and second diodes are light emitting diodes (LEDs).

5. The system of claim 2, wherein the optical converter comprises:
a third diode tuned to pass signals with a third frequency and the first amplitude; and
a fourth diode tuned to pass signals with a fourth frequency and the second amplitude,
wherein the third and fourth frequencies correspond to a frequency bandwidth of another communication signal.

6. The system of claim 5, wherein the first frequency is approximately 2.4 GHz and the second frequency is approximately 2.5 GHz.

7. The system of claim 6, wherein the third frequency is approximately 1800 MHz and the fourth frequency is approximately 1900 MHz.

8. The system of claim 5, wherein the first and third diodes are light diodes and the second and fourth diodes are dark diodes.

9. The system of claim 1, comprising:
an optical-to-wireless converter coupled to the optical demultiplexer,
wherein the optical-to-wireless converter is coupled to an antenna that transmits wireless communication signals corresponding to the voice or data communication signals carried on the powerline.

10. The system of claim 1, wherein an output of the optical demultiplexer is coupled to a transformer.

11. A system comprising:
a plurality of diodes coupled to a powerline;
an optical multiplexer coupled to the plurality of diodes; and
an optical demultiplexer coupled to the optical multiplexer,
wherein the plurality of diodes are tuned to a frequency and amplitude corresponding to voice or data communication signals carried on the powerline.

12. The system of claim 11, wherein the plurality of diodes comprises:
a first diode tuned to pass signals with a first frequency and a first amplitude; and
a second diode tuned to pass signals with a second frequency and a second amplitude,
wherein the first and second frequencies correspond to a frequency bandwidth of a communication signal.

13. The system of claim 12, wherein the first and second diodes are PIN diodes.

14. The system of claim 12, wherein the first and second diodes are light emitting diodes (LEDs).

15. The system of claim 12, wherein the plurality of diodes comprises:
a third diode tuned to pass signals with a third frequency and the first amplitude; and
a fourth diode tuned to pass signals with a fourth frequency and the second amplitude,
wherein the third and fourth frequencies correspond to a frequency bandwidth of another communication signal.

16. The system of claim 15, wherein the first frequency is approximately 2.4 GHz and the second frequency is approximately 2.5 GHz.

17. The system of claim 16, wherein the third frequency is approximately 1800 MHz and the fourth frequency is approximately 1900 MHz.

18. The system of claim 15, wherein the first and third diodes are light diodes and the second and fourth diodes are dark diodes.

19. The system of claim 11, comprising:
an optical-to-wireless converter coupled to the optical demultiplexer,
wherein the optical-to-wireless converter is coupled to an antenna that transmits wireless communication signals corresponding to the voice or data communication signals carried on the powerline.

20. The system of claim 11, wherein an output of the optical demultiplexer is coupled to a transformer.
